(19) United States
(12) Patent Application Publication
(10) Pub. No.: US 2026/0003097 A1
(43) Pub. Date: Jan. 1, 2026

(54) MONITORING SYSTEM

(71) Applicant: STUMATEC AG, Uebeschi (CH)

(72) Inventor: Daniel STUDER, Höfen (CH)

(21) Appl. No.: 18/865,886

(22) PCT Filed: May 19, 2023
(86) PCT No.: PCT/EP2023/063463

§ 371 Date: Aug. 6, 2025

(30) Foreign Application Priority Data
May 19, 2022 (EP) 22174228.1

(51) Int. Cl. G01V 8/20

(52) U.S. Cl. CPC G01V 8/20

(57) ABSTRACT

The invention is directed to a monitoring system (1) for moving machine parts (2), in particular of drilling equipment (3), having a sensor device (4) which comprises a plurality of adjacent sensors (12), which at least partially surround the machine part (2) to be monitored; a reference profile (5) which is arranged spaced apart from the sensor device (4), wherein the sensors (12) of the sensor device (4) are each configured to transmit measurement beams (M₁, M₂, M₃, M₄, M₅, M₆) to the reference profile (5); and a control device (7) having an evaluation unit (8) which is configured to compare the measured values (W₁, W₂, W₃, W₄, W₅, W₆) resulting from the measurement beams (M₁, M₂, M₃, M₄, M₅, M₆) with associated reference measured values (R₁, R₂, R₃, R₄, R₅, R₆) and to determine a measurement span (Δ) therefrom.

### TECHNICAL FIELD

The invention relates to a monitoring system for moving machine parts, in particular of drilling equipment, according to the preamble of independent claim 1.

In general, machines have functional moving parts. These can be, for example, shafts, spindles, press rams, drive elements, conveyors and the like. These parts are driven with comparatively high force. Persons and/or objects can therefore suffer considerable damage if they are in the area of movement of moving machine parts. There is also the danger that if the machine breaks down, parts of it could come loose and turn into projectiles that can be life-threatening.

In order to protect people and objects from the aforementioned dangers, it is known and partly mandatory to surround machines at least in parts with so-called machine guards. On the one hand, this makes it possible to catch flying parts, and on the other hand, unauthorized access to the machine from outside is not possible. The machine guards are designed differently depending on the manufacturer of the guard and have different mesh sizes and/or bends.

Machine guards as mechanical separating devices can be implemented quickly and easily and, at first glance, offer a high level of safety improvement. However, practice shows that such separating devices often make working with the device so difficult that the operating team has to find creative solutions to complete their task. This solution therefore has significant disadvantages which should be avoided if possible.

The disadvantages of mechanical separation devices described above are partially remedied by light barriers, which, however, can only detect the presence or absence of an object.

The same applies to light grids or safety light grids, which are used to monitor an entire area. In principle, several one-way light barriers are simply placed next to each other. As soon as a beam is interrupted, this is detected by the receiver.

### Prior Art

For example, DE 20 2011 051 295 U1 discloses a light grid with light transmitters and light receivers which, in pairs, form individual light barriers aligned parallel to one another, wherein the light transmitters and light receivers are arranged in at least one elongated aluminum housing and are each assigned to optical modules. The housing has a front window through which the light rays of the light barriers pass and the housing can be fixed to a mounting surface via at least one bracket. An optical module comprises a one-piece multiple lens with a plurality of lenses arranged adjacently in the longitudinal direction of the housing and connected to one another, as well as a one-piece tube body with a plurality of tubes arranged adjacently in the longitudinal direction of the housing, and a one-piece diaphragm carrier with a plurality of diaphragm openings arranged adjacently in the longitudinal direction of the housing. In each case, a tube, a lens and a diaphragm opening are aligned with each other and define an optical axis of a light beam, wherein the alignment is achieved by plugging together the tube body, the multiple lens and the diaphragm carrier to form the optical module. The thermal expansion coefficients of the tube body, diaphragm carrier and aluminum housing are the same.

However, even with this solution the distance of an object cannot be detected.

3D cameras, on the other hand, provide optical images for object recognition, which are additionally equipped with depth information. This is done using TOF measurement technology (the abbreviation TOF stands for Time-of-Flight). This depth information can be used to determine how far away objects are from the camera. By defining different zones, permitted and prohibited areas can be distinguished.

A corresponding 3D camera is described in DE 20 2014 101 550 U1, for example, where the 3D camera is specifically equipped with an image sensor for capturing three-dimensional image data from a field of view and with a panoramic mirror optic arranged in front of the image sensor. The geometry of the panoramic mirror optics does not form a body of rotation in order to improve the panoramic mirror optics. By dispensing with the body of rotation, it is possible to ensure continuous monitoring over a large angular range, but the shape allows a redistribution of the measuring points and thus to detect particularly interesting sub-regions more precisely at the expense of less interesting sub-regions.

It should be noted, however, that 3D cameras have relatively high acquisition costs, which are usually not profitable, especially for monitoring drilling rigs. In addition, 3D cameras are often not sufficiently robust for use in drilling, for example.

The present invention is therefore based on the object of providing a solution for a non-mechanical protective grid, in particular for moving machine parts of drilling equipment, which ensures reliable and at the same time cost-effective distance measurement.

### Presentation of the Invention

The object is achieved according to the invention by a monitoring system according to independent claim 1. Advantageous embodiment variants of the invention emerge from the dependent claims.

The essence of the invention consists in the following: A monitoring system for moving machine parts, in particular for moving machine parts of drilling equipment. The monitoring system has a sensor device which comprises a plurality of adjacent sensors, which at least partially surround the machine part to be monitored. The monitoring system further comprises a reference profile which is arranged spaced apart from the sensor device, wherein the sensors of the sensor device are each configured to transmit measurement beams to the reference profile. Finally, the monitoring system comprises a control device having an evaluation unit which is configured to compare the measured values resulting from the measurement beams with associated measured reference values and to determine a measurement span therefrom.

This form of difference determination makes it in particular possible to achieve independence of the system from the current position of the moving machine part (as well as the sensor device). Areas of application comprise drilling equipment of any kind. Applications in other areas, such as construction technology or storage technology, are also conceivable (namely generally where moving machine parts can represent a risk to workers).

In the present case, the term “transmitting a measurement beam” comprises the output of a sensor signal, usually in the form of a beam, and the reception of a corresponding return signal, usually in the form of a beam, reflected from a known body or from a foreign body.

The term “reference profile” in the present case comprises the surface of a known body scanned by the sensors (such as a crusher which surrounds the borehole and possibly part of the drilling carriage and the like) and possibly another surface which does not belong to the known body and is possibly at a different height level than the surface of the known body (such as a ground surface which is surrounded by the crusher and the like). In principle, the reference profile can also consist only of a ground surface and/or another surface which is not specific to the equipment.

Preferably, the evaluation unit is configured to determine the measurement span from the difference between the maximum deviation of a measured (distance) value from the associated reference (distance) value and the minimum deviation of a measured (distance) value from the associated reference (distance) value. This form of evaluation has proven to be particularly efficient and reliable in practice.

Preferably, the control device is also configured to trigger a detection signal when the measurement span determined by the evaluation unit reaches or exceeds a predefined limit value. In this way, a moving machine part or the associated machine can be quickly stopped if a foreign body is detected.

During operation, the sensor device preferably moves with the machine part to be monitored. The sensor device is usually attached to the moving machine part, such as a drilling rig, which makes its use particularly precise and effective.

Preferably, the sensors of the sensor device comprise laser distance sensors, each of which comprises a laser diode for outputting a laser beam to the reference profile and an (integrated) receiver for receiving the laser beam reflected by the reference object or by a foreign object. The laser beam is therefore the measurement beam here. The use of laser distance sensors (time of flight measurement) has proven to be both cost-effective and not error-prone. However, other types of distance measuring sensors, which use a triangulation method or phase modulation, for example, can also be used to carry out the distance measurement according to the invention. The use of radar sensors is also conceivable.

In principle, it is also possible to carry out the distance measurement according to the invention using one or more 3D cameras; however, this is usually less efficient for cost reasons.

Preferably, the sensor device is formed from one or more measurement bars comprising the sensors which surround the machine part to be monitored. These can be easily arranged or mounted, for example, at the upper end of a drilling equipment and have proven to be practical components for the sensors.

Preferably, the one or more measurement bars form a laser grid around the machine part to be monitored during operation. This sort of virtual laser grid offers more effective protection than the often bulky mechanical separating devices (such as the machine guards mentioned above).

Preferably, the one or more measurement bars are configured to form a polygonal, rectangular, square, triangular, round or oval laser grid around the machine part to be monitored. The geometric design of the laser protection grid is regularly adapted to the respective area of application and the respective location. In particular, the measurement bars with the sensors are guided linearly along or parallel to the drilling or central axis, so that the individual sensors of the laser grid are always moved on the same vertical line.

Preferably, the minimum distance between the machine part to be monitored and the laser grid is about 5 cm, preferably about 10 cm and more preferably about 12 cm. In these ranges, optimum protection is provided, particularly for use with drilling equipment. Other distances are conceivable for other applications.

Preferably, the measurement bars have a length of about 400 mm to about 500 mm and preferably a length of about 450 mm. These dimensions have proven to be particularly practical for use in drilling equipment. Other lengths are conceivable for other applications.

Preferably, the number of sensors per measurement bar is from about 10 to about 18, and preferably from about 14 to about 16. These numbers have proven to be particularly efficient, especially for use in drilling equipment. Accordingly, other quantities are conceivable for other applications.

Preferably, the axial distance between the individual sensors is from about 25 mm to about 35 mm and preferably equal to about 30 mm. In this way, a protective grid with the tightest possible mesh can be achieved while at the same time minimizing mutual influence between the sensors.

Preferably, a measurement distance of the sensor device is between about 1 cm and about 10 m, preferably between about 5 cm and about 5 m, and more preferably between 3 cm and 3 m. Within these distances, the monitoring system according to the invention works particularly reliably.

Preferably, a measurement frequency of the sensors is from about 10 Hz to about 50 Hz and preferably about 30 Hz. These frequency ranges provide a particularly good system response time and thus a high measurement accuracy.

Preferably, the sensors are controlled sequentially. This measure also serves to ensure a particularly high level of measurement accuracy.

### BRIEF DESCRIPTION OF THE DRAWINGS

Further advantageous embodiments of the invention will become apparent from the following description of embodiments of the invention with the aid of the schematic drawing. In particular, the system according to the invention is described in more detail below with reference to the accompanying drawings using exemplary embodiments. In particular:

FIG. 1: shows an exemplary measurement bar for a sensor device in a monitoring system according to the invention;

FIG. 2: shows a schematic representation of the structure of a monitoring system according to the invention using an exemplary drilling equipment;

FIG. 3: shows a schematic representation of a monitoring system according to the invention when detecting the measured reference values;

FIG. 4: shows a schematic representation of a monitoring system according to the invention in an exemplary scenario A in which no foreign object is present;

FIG. 5: shows a schematic representation of a monitoring system according to the invention in an exemplary scenario B in which a foreign object is present; and

FIG. 6: shows a table with exemplary numerical values for in particular the reference values, measured values and measurement spans of the present example scenarios A and B.

### MODE(S) OF CARRYING OUT THE INVENTION

Certain expressions may be used in the following description for convenience only and are not intended to be limiting. The words “right”, “left”, “lower” and “upper” indicate directions in the drawing to which reference is made. The terms “inward”, “outward” “below”, “above”, “left”, “right” or similar are used to describe the arrangement of designated parts to each other, the movement of designated parts to each other and the directions to or from the geometric center of the invention, and named parts of the same as shown in the figures. These spatial relative specifications also comprise positions and orientations other than those shown in the figures. For example, if a part represented in the figures is reversed, elements or features described as “below” become “above”. The terminology includes the words expressly mentioned above, derivatives thereof and words of similar meaning.

In order to avoid repetitions in the figures and the associated description of the various aspects and embodiments, certain features should be understood as common to different aspects and embodiments. The omission of an aspect in the description or a figure does not imply that this aspect is missing in the corresponding exemplary embodiment. Rather, such omission can serve to provide clarity and prevent repetition. In this context, the following definition applies to the entire further description: If reference numerals are included in a figure for the purpose of graphic clarity, but are not mentioned in the directly associated descriptive text, reference is made to their explanation in preceding figure descriptions. Furthermore, if the descriptive text directly associated with a figure contains reference numerals which are not contained in the associated figure, reference is made to the preceding and following figures. Similar reference numerals in two or more figures represent similar or identical elements.

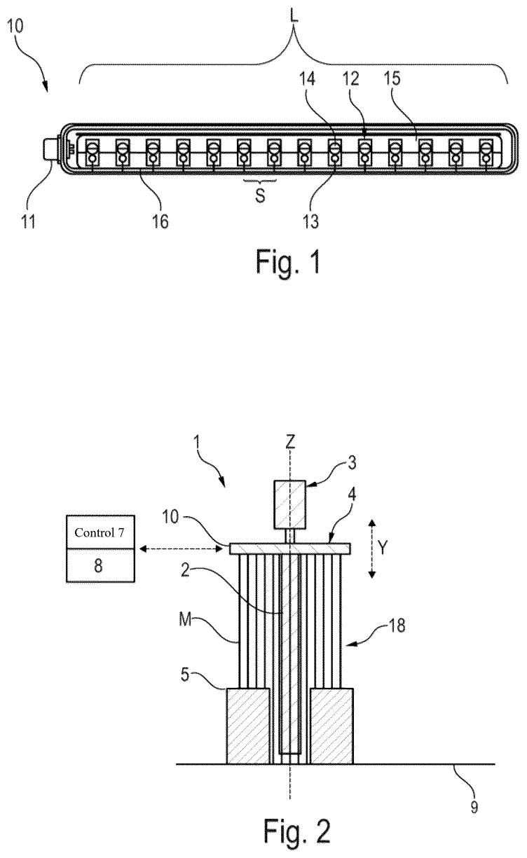

FIG. 1 illustrates an exemplary measurement bar 10 for a sensor device of a monitoring system according to the invention. The measurement bar 10 comprises a housing 16 in which a sensor holder 15 for the individual sensors 12 is arranged. Each of the sensors 12 shown, which are designed here as laser sensors by way of example, comprises a laser diode 13 for emitting a laser beam and a receiver 14 for receiving the laser beam reflected by a neutral object (e.g. a stone) or a foreign object. A connector 11 is arranged on the side of the housing 16 of the measurement bar 10. In the present example, the measurement bar 10 comprises a total of fourteen laser sensors 12, but depending on the area of application, there may be more or fewer sensors. The distance between the individual sensors 12 or the laser beams emitted by the light-emitting diode is given here as the axial distance S. The axial distance S between the individual sensors should be approximately 25 mm to approximately 35 mm and preferably approximately 30 mm in order to avoid any mutual influences. As a possible corrective measure, a sequential control of the sensors is provided.

In FIG. 2, the structure of a monitoring system 1 according to the invention is schematically illustrated using an exemplary drilling equipment 3. The drilling equipment 3 with the central or drilling axis Z comprises a drilling carriage 2 as a movable machine part. At the upper end of the drilling carriage 2, a measurement bar 10 of a sensor device 4 is shown, wherein the sensor device 4 is mounted on the drilling carriage 2 or on the drilling equipment 3. During operation, the sensor device 4 is moved along with the drilling carriage 2 in the Y direction and comprises the (laser) sensors which emit the individual measurement beams M. The totality of the measurement beams M forms the laser grid 18 around the drilling carriage 2. In the region of the ground 9, the drilling equipment 2 is at least partially surrounded by a reference object or a crusher 5, which together with the ground 9 forms a reference profile 5, 9, which serves to determine the measured reference values R. The sensor device 4 is connected to a control device 7, which has an evaluation unit 8. The connection between the sensor device 4 and the control device 7 can be made by means of suitable connecting elements (e.g. cables or lines, etc.) or wirelessly. The control device 7 is further connected to a drive of the drilling equipment 3, which, however, is not separately shown here.

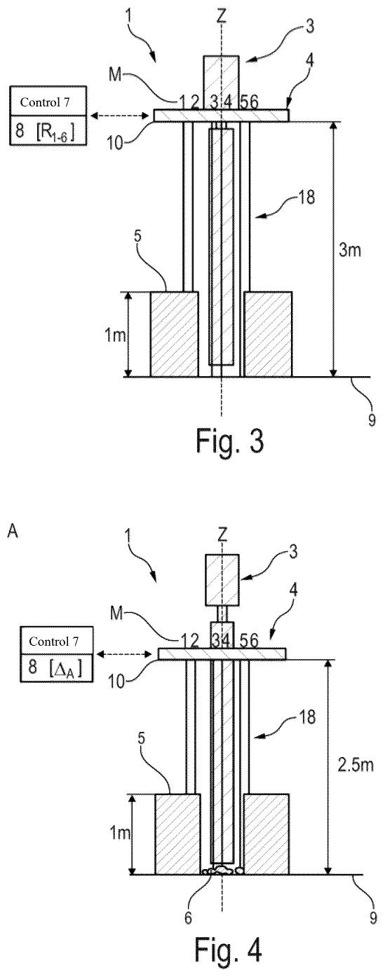

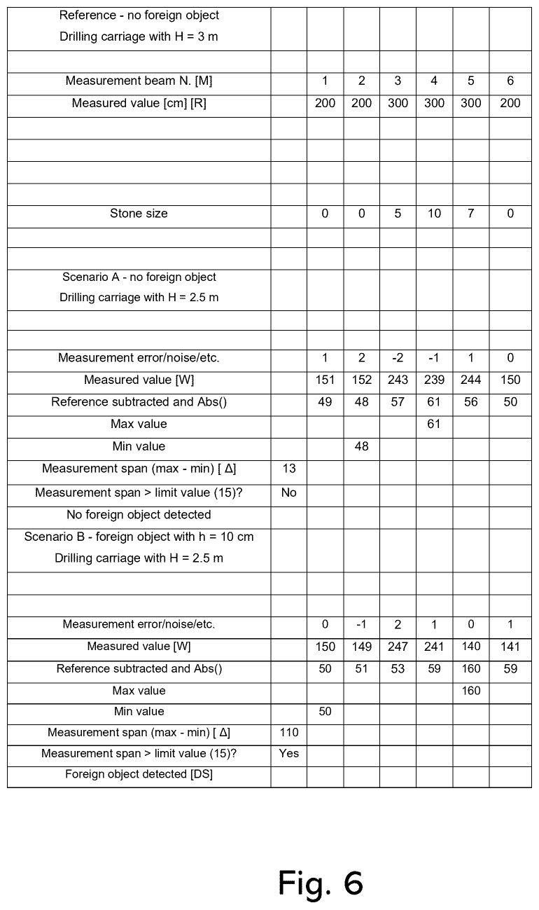

FIG. 3 shows, by way of example, a schematic representation of a monitoring system 1 according to the invention when detecting the measured reference values R₁₋₆. The measured reference values R₁₋₆ can be detected in any position of the drilling carriage 2 using the sensor device 4. In the present case, purely as an example, the distance between the lower edge of the sensor device 4 and the ground 9 is three meters. The crusher 5 has a height of one meter. The measurement beams M₁, M₂, M₃, M₄, M₅ and M₆ of the corresponding sensors, which are now shown individually for better illustration, form the laser grid 18, with the reference profile 5, 9 which is formed by the top of the crusher 5 and by the surface of the ground 9. For the measurement beams M₁ and M₂, as indicated in the table in FIG. 6, the measured reference values R₁ and R₂ are each 200 cm, for the measurement beams M₃, M₄ and M₅ the measured reference values R₃, R₄ and R₅ are each 300 cm and for the measurement beam M₆ the measured reference value R₆ is 200 cm.

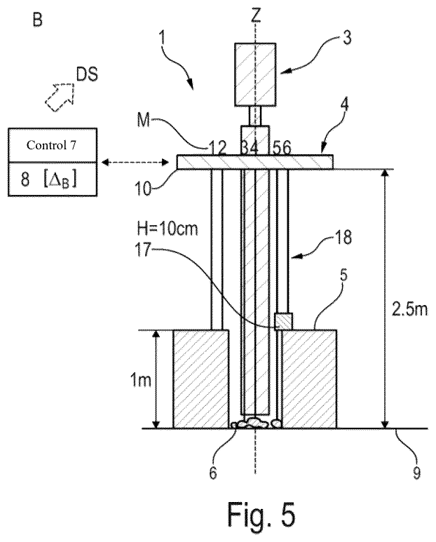

If the drilling equipment 3 or the drilling carriage 2 with the sensor device 4 is now moved downwards during operation, the example scenarios A and B shown below with reference to FIGS. 4 and 5 result for the operation of the monitoring system 1 according to the invention or for determining whether or not a foreign object is located in the area monitored by the laser grid 18 around the moving machine part or the drilling carriage 3. It should also be noted that the sensor device 4 is guided linearly along or parallel to the drilling or central axis Z, so that the individual sensors of the laser grid 18 are always moved on the same vertical line, which are represented here by the measurement beams M₁, M₂, M₃, M₄, M₅ and M₆.

In FIG. 4, a schematic representation of a monitoring system 1 according to the invention is shown in the exemplary scenario A in which no foreign object is located in the area monitored by the laser grid 18. Now the distance between the lower edge of the sensor device 4 and the ground 9 is only two and a half meters. The crusher 5 has a height of one meter. Below the drilling carriage 3 there are stones or neutral bodies 6 on the ground 9. The stone under the measurement beam M₃ has a size or height of 5 cm, the stone under the measurement beam M₄ has a size or height of 10 cm and the stone under the measurement beam M₅ has a size or height of 7 cm.

For the measurement beams M₁ and M₂ the measured values W₁=151 cm and W₂=152 cm result. For the measurement beams M₃, M₄ and M₅ the measured values W₃=243 cm, W₄=239 cm and W₅=244 cm result and for the measurement beam M₆ the measured value W₆ is 150 cm. These measured values W₁, W₂, W₃, W₄, W₅ and W₆ are again shown in the table according to FIG. 6 for scenario A. The evaluation unit 8 determines the measurement span Δ_{A}=13 cm from the smallest difference between the measured value W₂ and the reference value R₂ and the largest difference between the measured value M₄ and the reference value R₄. The limit value for triggering a detection signal by the control unit 7 was set at 15 cm for the two example scenarios A and B discussed here, so that no detection signal is triggered by the determined measurement span A_{A} in this case (namely because only stones or neutral bodies 6 were detected and no foreign body).

FIG. 5 shows a schematic representation of a monitoring system 1 according to the invention in the exemplary scenario B, in which a foreign object 17 (namely for example, an arm or a hand of a worker) with a height or size of 10 cm is located in the area monitored by the laser grid 18 (namely on the right side of the crusher 5 under the measurement beams M₅ and M₆; the foreign object does not necessarily have to be on the crusher 5, the system according to the invention detects a foreign object in any position between the crusher 5 and the sensor device 4 or between the ground 9 and the sensor device 4). The distance between the lower edge of the sensor device 4 and the ground 9 is still two and a half meters. The crusher 5 still has a height of one meter. Below the drilling carriage 3 there are stones or neutral bodies 6 on the ground 9. The stone under the measurement beam M₃ still has a size or height of 5 cm, the stone under the measurement beam M₄ still has a size or height of 10 cm and the stone under the measurement beam M₅ still has a size or height of 7 cm.

For the measurement beams M₁ and M₂ the measured values W₁=150 cm and W₂=149 cm result. For the measurement beams M₃, M₄ and M₅ the measured values W₃=247 cm, W₄=241 cm and W₅=140 cm result and for the measurement beam M₆ the measured value W₆ is 141 cm. These measured values W₁, W₂, W₃, W₄, W₅ and W₆ are correspondingly shown in the table according to FIG. 6 for scenario B. The evaluation unit 8 determines in this case the measurement span Δ_{B}=110 cm from the smallest difference between the measured value W₁ and the reference value R₁ and the largest difference between the measured value M₅ and the reference value R₅. The limit value for triggering a detection signal by the control device 7 was set, as mentioned, at 15 cm for the two exemplary scenarios A and B discussed here, so that a detection signal DS is triggered by the determined measurement span Δ_{B} in this case (namely because a foreign body 17 was detected). The detection signal DS can, for example, cause the drive of the drilling equipment 3 to be switched off immediately.

As already explained above, FIG. 6 comprises the table with the numerical values for in particular the reference values R₁ to R₆, the measured values M₁ to M₆ and the measurement spans Δ_{A} and Δ_{B} of the two previously discussed exemplary scenarios A and B for operation of the monitoring system 1 according to the invention.

The present disclosure also comprises embodiments of the system according to the invention having any combination of features mentioned or shown above or below for various embodiments. It also comprises individual features in the figures, even if they are shown there in connection with other features and/or are not mentioned above or in the following. The alternatives of embodiments described in the figures and the description and individual alternatives of their features may also be excluded from the subject matter of the invention or from the disclosed subject matters. The disclosure includes embodiments that exclusively include the features described in the claims or in the exemplary embodiments, as well as those that include additional other features.

In addition, the term “comprise” and derivations thereof do not exclude other elements or steps. Also, the indefinite article “a” or “an” and derivatives thereof do not exclude a large number. The functions of multiple features listed in the claims can be fulfilled by one unit or one step. In particular, the terms “substantially,” “approximately,” “about,” and the like in combination with a property or value define exactly the property or value. The terms “approximately” and “about” associated with a given number or range may refer to a value or range that is within 20%, within 10%, within 5%, or within 2% of the given value or range.

### List of Reference Numerals

1 Monitoring system
2 Drilling carriage
3 Drilling equipment
4 Sensor device
5 Reference object (crusher)
6 Neutral body (stones etc.)
7 Control device
8 Evaluation unit
9 Ground
10 Measurement bar
11 Connector
12 Sensor
13 Laser diode
14 Receiver
15 Sensor holder
16 Housing
17 Foreign body
18 Laser grid
DS Detection signal
L Length of measurement bar
M₁₋₆ Measurement beams
R₁₋₆ Reference values
S Axial distance
W₁₋₆ Measured values
Y Direction of movement
Z Central or drilling axis
Δ_{A,B} Measurement spans

1. A monitoring system for moving machine parts, the monitoring system comprising:
a sensor device which comprises a plurality of adjacent sensors, which at least partially surround the machine part to be monitored;
a reference profile which is arranged spaced apart from the sensor device, wherein the sensors of the sensor device are each configured to transmit measurement beams to the reference profile; and
a control device having an evaluation unit which is configured to compare the measured values resulting from the measurement beams with associated measured reference values and to determine a measurement span therefrom.

2. The monitoring system according to claim 1, wherein the evaluation unit is configured to determine the measurement span from the difference between the maximum deviation of a measured value from the associated reference value and the minimum deviation of a measured value from the associated reference value.

3. The monitoring system according to claim 2, wherein the control device is configured to trigger a detection signal when the measurement span determined by the evaluation unit reaches or exceeds a predefined limit value.

4. The monitoring system according to claim 1, wherein during operation the sensor device moves with the machine part to be monitored.

5. The monitoring system according to claim 1, wherein the sensors of the sensor device comprise laser distance sensors, each comprising a laser diode for outputting a laser beam to the reference profile and a receiver for receiving the laser beam reflected by the reference object or by a foreign object.

6. The monitoring system according to claim 1, wherein the sensor device is formed from one or more measurement bars comprising the sensors which surround the machine part to be monitored.

7. The monitoring system according to claim 1, wherein the one or more measurement bars form a laser grid around the machine part to be monitored during operation.

8. The monitoring system according to claim 1, wherein the one or more measurement bars are configured to form a polygonal, rectangular, square, triangular, round or oval laser grid around the machine part to be monitored.

9. The monitoring system according to claim 1, wherein the minimum distance between the machine part to be monitored and the laser grid is approximately 5 cm, preferably approximately 10 cm and more preferably approximately 12 cm.

10. The monitoring system according to claim 1, wherein the measurement bars have a length of about 400 mm to about 500 mm and preferably a length of about 450 mm.

11. The monitoring system according to claim 1, wherein the number of sensors per measurement bar is from about 10 to about 18, and preferably from about 14 to about 16.

12. The monitoring system according to claim 1, wherein the axial distance between the individual sensors is from about 25 mm to about 35 mm and preferably about 30 mm.

13. The monitoring system according to claim 1, wherein a measurement distance of the sensor device is between about 1 cm and about 10 m, preferably between about 5 cm and about 5 m and more preferably between 3 cm and 3 m.

14. The monitoring system according to claim 1, wherein a measurement frequency of the sensors is from about 10 Hz to about 50 Hz, and preferably about 30 Hz.

15. The monitoring system according to claim 1, wherein the control of the sensors takes place sequentially.
